(19) United States
(12) Patent Application Publication
(10) Pub. No.: US 2012/0058284 A1
(43) Pub. Date: Mar. 8, 2012

(54) INVISIBLE PATTERN CONTAINED PLASTIC LABEL

(76) Inventor: SHIH-SHENG YANG, Taipei Hsien (TW)

(21) Appl. No.: 12/906,146

(22) Filed: Oct. 18, 2010

(30) Foreign Application Priority Data
Sep. 2, 2010 (TW) 099217044

(51) Int. Cl. B44F 1/10; B32B 3/30

(52) U.S. Cl. 428/29

(57) ABSTRACT

An invisible pattern contained plastic label has a surface on which a plurality of sharp tip bodies is formed and successively arranged in a matrix. Each of the sharp tip bodies has at least first and second sides each forming a slope. A first pattern is formed on the slopes of the first sides of the sharp tip bodies, and a second pattern is formed on the slopes of the second sides of the sharp tip bodies. Each of the patterns has a reference plane that shows a difference in depth with respect to a surface of the respective slope. The surfaces of the slopes and the patterns formed thereon are of different roughness so as to form an arrangement of showing multiple patterns, which provides a displaying result of showing variable multi-layered perception of invisible patterns to thereby improve product quality.

### (a) TECHNICAL FIELD OF THE INVENTION

The present invention generally relates to an invisible pattern contained plastic label, and more particularly to a label containing at least a first pattern and a second pattern that can be selectively displayed through rotation of the label.

### (b) DESCRIPTION OF THE PRIOR ART

A conventional way of forming invisible pattern contained products is to apply embossment techniques to make the product. This is commonly known as “invisible embossment technique”, wherein a plurality of raised portions is successively arranged in a matrix, which forms reflection slope surfaces on which a desired pattern is formed. Through a specific reflection angle defined by the reflection slope surfaces, light is refracted t show the pattern. One of the commonly seen examples is the patterns formed on a coin. A user may simply rotate the coin to show the patterns at different viewing angles. However, such an embossment technique is subjected to limitation imposed by the light reflection characteristics of the material used so that it cannot be widely applied to various products made of different materials.

In view of such problems, Taiwan Utility Model No. M303122 discloses a structure of multi-layer displaying of engraving surface, wherein a body to be engraved forms a plurality of rectangular ribs that is successively arranged in a matrix. A specific portion of each rib is removed to form a slope surface according to a desired pattern, so that variation of viewing angle can be taken to display patterns in a multi-layered and overlapping image. Since such a structure shows the pattern through viewing slope surfaces formed by removing material rather than through light reflection, it can be widely used in various materials of both low and high reflectivity. However, due to such a structure being formed by cutting material, the manufacturing is complicated and time-consuming. Further, such a cutting process for manufacturing cannot be applied to fine objects, making it insufficient for applications.

In view of such problems, the present invention aims to provide a solution to overcome such problems.

### SUMMARY OF THE INVENTION

The primary objective of the present invention is to provide an invisible pattern contained plastic label, which is manufactured by employing precise arc discharge machining to form a plurality of sharp tip bodies that has two side sloping surfaces on which successive fractions of desired patterns are formed in a mold cavity and making the sloping surfaces and the patterned portions showing different surface roughness to realize displaying of invisible patterns.

To achieve the above objective, the present invention is carried out with the following steps:

(a) Preparing molding die: A die plate 20 is provided and machined to form a cavity that has a shape corresponding to a predetermined contour of a label to be made and further forming a plurality of sharp tip bodies, which is successively arranged in a matrix, on a portion of the cavity that corresponds to a portion of the label to be made where the invisible pattern is to be formed.

(b) Forming pattern: Arc discharge machining is carried out on sloping surfaces of different sides of the sharp tip bodies to form desired patterns and making the machined portion and un-machined portion of each side showing a contrast of different surface roughness.

(c) Injection molding: The die plate so prepared is used in an injection molding machine to carry out injection molding of plastics and thus, a label showing variable three-dimensional multi-layered displaying results of invisible patterns is manufactured, which improves visual perception of the manufactured products and increases product quality and also simplifies the manufacturing and reduces costs.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a label constructed in accordance with the present invention.

FIG. 1a is a partial enlarged view of the label of the present invention.

FIG. 2 is a schematic view showing viewing invisible patterns formed on the label of the present invention from different viewing angles.

FIG. 3 is a perspective view showing the label of the present invention viewed from a viewing angle to display a first pattern.

FIG. 4 is a perspective view showing the label of the present invention viewed from another viewing angle to display a second pattern.

FIG. 5 is a perspective view showing a label constructed in accordance with another embodiment of the present invention.

FIG. 6 schematically illustrates step (a) of preparing mold die according to a manufacturing process of the present invention.

FIG. 7 schematically illustrates first half of step (b) of forming pattern according to the manufacturing process of the present invention.

FIG. 8 schematically illustrates second half of step (b) of forming pattern according to the manufacturing process of the present invention.

FIG. 9 schematically illustrates step (c) of injection molding according to the manufacturing process of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

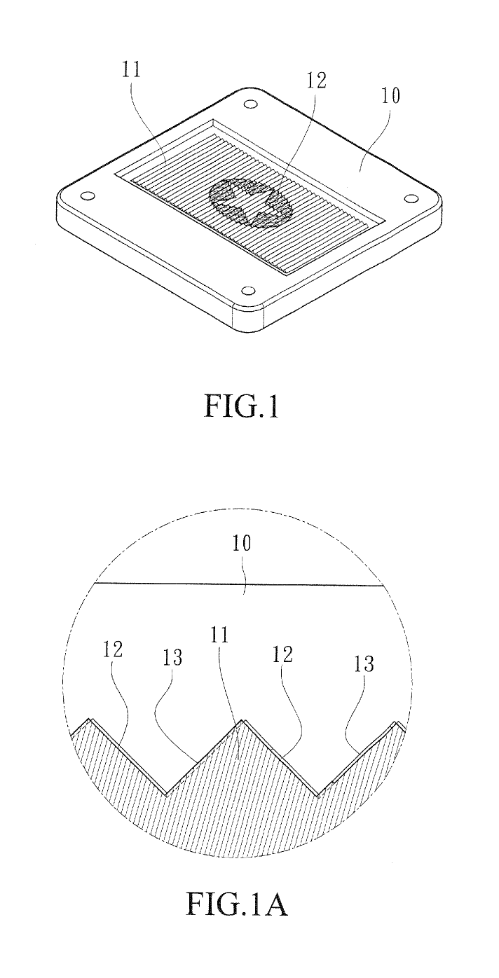

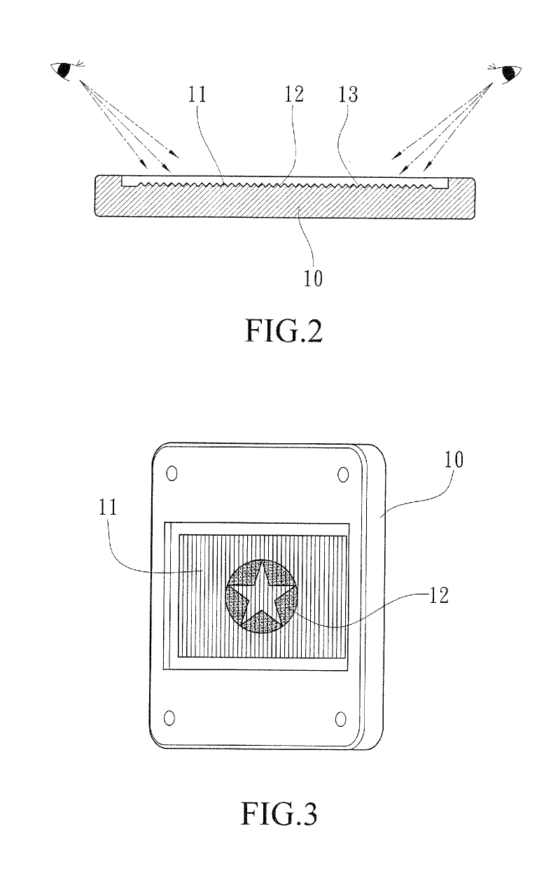

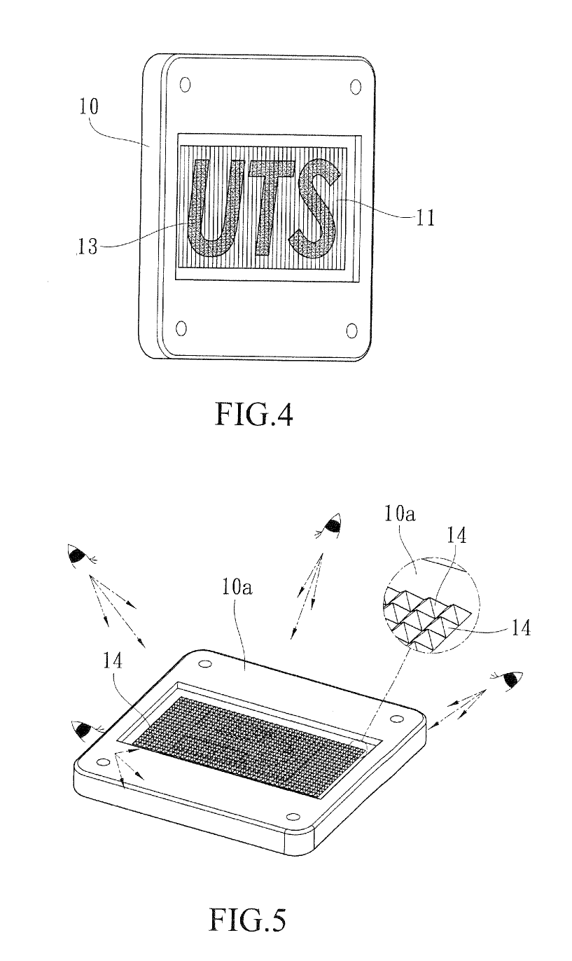

Referring to FIGS. 1, 1a, and 2, an invisible pattern contained plastic label constructed in accordance with the present invention is generally shown at 10. The label 10 has a surface on which a plurality of sharp tip bodies is formed and is successively arranged as an array or matrix. Each of the sharp tip bodies has at least two different sides each forming a sloping surface. In the embodiment illustrated, the sharp tip body is an elongate triangular rib 11, which has a right side sloping surface and a left side sloping surface. The right side sloping surfaces of the triangular ribs 11 are provided in a successive fashion with successive fractions of a first pattern 12 formed thereon, as shown in FIG. 3. Similarly, the left side sloping surfaces of the triangular ribs 11 are provided in a successive fashion with successive fractions of a second pattern 13, as shown in FIG. 4. The fractions of the first pattern 12 and the second patterns 13 are formed in the sloping surfaces in such a way that a reference plane of each fraction of the first pattern 12 or the second pattern 13 has a difference in depth with respect to the sloping surface on which the fraction of pattern is formed. Such a depth difference is caused by the process of machining, such as arc discharge machining. Thus, the fraction of the pattern formed on the respective sloping surface can be such that the pattern fraction is recessed with respect to the sloping surface, or alternatively, the sloping surface is machined in such a way that portions of the sloping surface other than where the pattern fraction is formed are removed by arc discharge machining and are thus recessed, so that the pattern fraction formed on the sloping surface is raised with respect to the sloping surface. The sloping surface and the pattern fraction formed thereon may thus show or may be of different surface roughness, so that when the label is set at different angular positions through rotation, different patterns can be shown.

Referring to FIGS. 2-4, the label 10 according to the present invention is constructed by forming the “invisible” patterns on opposite side sloping surfaces of a plurality of triangular ribs 11 that is successively arranged in an array or a matrix. When a user rotates the label 10 to different angular positions, or views the label 10 from different angles (as shown in FIGS. 3 and 4), the first pattern 12 or the second pattern 13 is displayed, showing a layered visual perception due to light refraction, so that the display of the different patterns can be easily identified.

Referring to FIG. 5, a label 10a constructed in accordance with another embodiment of the present invention is shown. The label 10a forms a plurality of sharp tip bodies on which invisible patterns are formed. In the embodiment illustrated, the sharp tip bodies are a plurality of tetragonal pyramids 14, which is successively arranged in an array or a matrix. The tetragonal pyramid has four sides so that four different patterns can be respectively formed on four sloping surfaces respectively defined by the four sides. In this way, multiple patterns can be selectively displayed and when a user rotates the label 10a or views the label from different angles, variation of the pattern displayed can be effected. Besides being tetragonal pyramids, the sharp tip bodies can also be pentagonal pyramids, hexagonal pyramids or other polygonal pyramids.

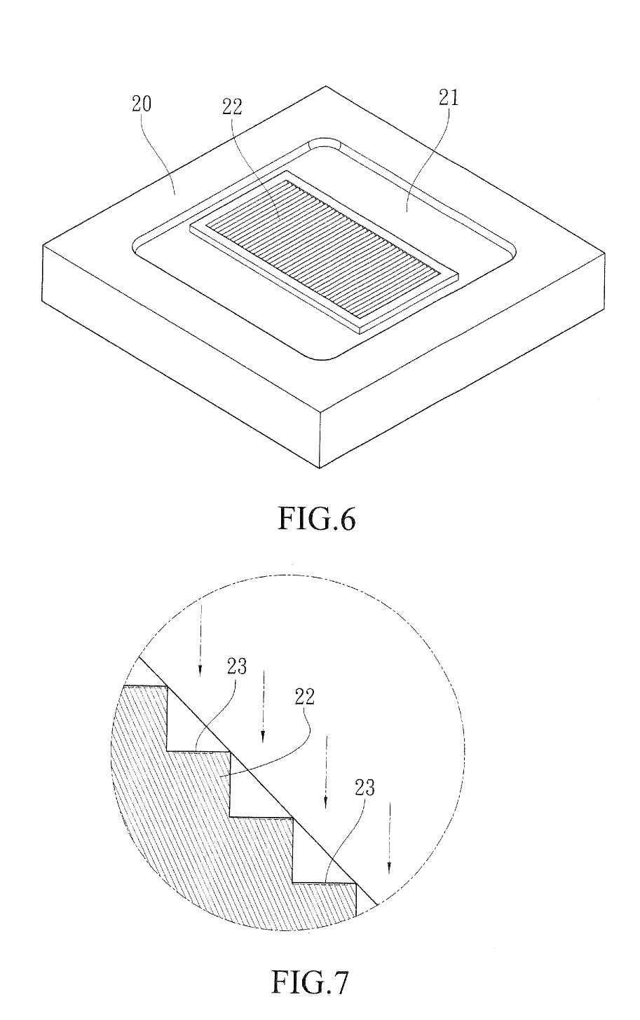

Referring to FIGS. 6-9, a process for manufacturing the invisible pattern contained plastic label according to the present invention will be described.

(a) Preparing molding die: A die plate 20 is provided and a machine tool is used to machine the die plate for forming a cavity 21 that has a shape corresponding to a predetermined contour of a label to be made in a surface of the die plate and further forming a plurality of sharp tip bodies 22, which is successively arranged in an array or a matrix, on a portion of the cavity 21 that corresponds to a portion of the label to be made where the invisible pattern is to be formed (as shown in FIG. 6).

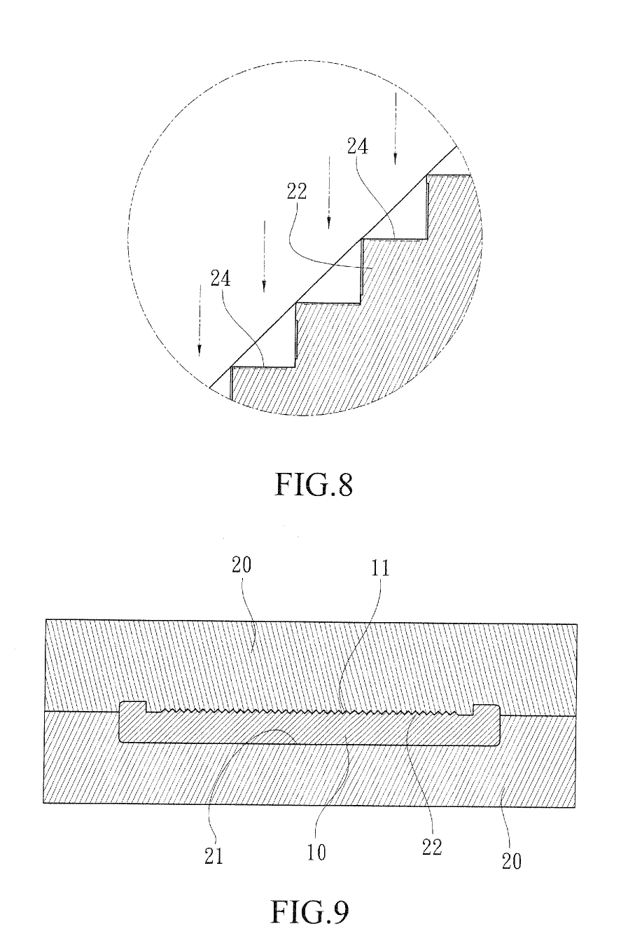

(b) Forming pattern: The die plate 20 is set in an inclined manner to have first sides (such as left sides) 23 of the sharp tip bodies 22 formed inside the cavity 21 horizontally set and arc discharge machining is carried out to apply high-voltage currents to the first sides of the sharp tip bodies to form a desired pattern, such as forming a first pattern 12, of which successive fractions are respectively formed on successive ones of the first sides and at the same time making the machined portion and un-machined portion of each side showing a contrast of different surface roughness (as shown in FIG. 7). A similar process is applied to form a second pattern 13 on second sides (such as right sides) 24 of the sharp tip bodies 22 in a successively arranged manner (as shown in FIG. 8).

(c) Injection molding: The die plate 20 so prepared is used in an injection molding machine to carry out injection molding of plastics (as shown in FIG. 9) and thus, a label 10 showing variable three-dimensional multi-layered displaying results of invisible patterns is manufactured.

Such a manufacturing process increases quality and added value of the product, stimulates purchase desire of general consumers, and is applicable to complicated and fine products through the application of precise arc discharge machining. Further, the manufacturing process is carried out with simple steps with shortened production cycle so that it is fit for mass production of customized products and is effective in improving productivity and reducing manufacturing cost.

Further, step (b) of forming pattern of the manufacturing process according to the present invention can be carried out with laser machining by etching a desired pattern on sloping surfaces of the sides of the sharp tip bodies. A result similar to what discussed above can also be realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An invisible pattern contained plastic label, characterized in that:
the label has a surface on which a plurality of sharp tip bodies is formed and successively arranged in a matrix, each of the sharp tip bodies having at least first and second sides each forming a slope, a first pattern being formed on the slopes of the first sides of the sharp tip bodies, a second pattern being formed on the slopes of the second sides of the sharp tip bodies, each of the patterns having a reference plane that shows a difference in depth with respect to a surface of the respective slope, the surfaces of the slopes and the patterns formed thereon being of different roughness so as to form an arrangement of showing multiple patterns.

2. The invisible pattern contained plastic label according to claim 1, wherein the sharp tip bodies comprise triangular ribs, which have right side slopes on which the first pattern is formed and left side slopes on which the second pattern is formed.

3. The invisible pattern contained plastic label according to claim 1, wherein the sharp tip bodies comprise tetragonal pyramids.

4. The invisible pattern contained plastic label according to claim 1, wherein the reference planes of the first and second patterns are made recessed with respect to surfaces of the slopes on which the patterns are formed.

5. The invisible pattern contained plastic label according to claim 1, wherein the reference planes of the first and second patterns are made raised with respect to surfaces of the slopes on which the patterns are formed
